(19) United States
(12) Patent Application Publication
(10) Pub. No.: US 2026/0301270 A1
(43) Pub. Date: Oct. 1, 2026

(54) AUTOMATIC DATASET CREATION AND SCORER FOR IMAGE EDITING EVALUATION

(71) Applicant: SAMSUNG ELECTRONICS CO, LTD., Suwon-si (KR)

(72) Inventors: Xiaotong CHEN, Goleta, CA (US); Suren KUMAR, Seattle, WA (US); Yi WEI, Sunnyvale, CA (US); Luowei ZHOU, Bellevue, WA (US)

(73) Assignee: SAMSUNG ELECTRONICS CO, LTD., Suwon-si (KR)

(21) Appl. No.: 19/631,320

(22) Filed: Mar. 27, 2026

Related U.S. Application Data
(60) Provisional application No. 63/779,055, filed on Mar. 27, 2025.

(51) Int. Cl. G06T 11/60; G06N 3/08

(52) U.S. Cl. CPC G06T 11/60; G06N 3/08

(57) ABSTRACT

Methods, systems, and apparatuses for performing image processing, including: obtaining a reference image and an editing instruction for editing the reference image; obtaining an edited image corresponding to the reference image and the editing instruction; providing the reference image, the editing instruction, and the edited image to an artificial intelligence (AI) editing evaluation model to obtain an editing evaluation score; and modifying at least one parameter of the editing evaluation model based on a comparison between the editing evaluation score and a ground truth editing evaluation score corresponding to the reference image, the editing instruction, and the edited image.

### CROSS-REFERENCE TO RELATED APPLICATION(S)

This application is based on and claims priority under 35 U.S.C. § 119 to U.S. Provisional Patent Application No. 63/779,055, filed on Mar. 27, 2025, in the U.S. Patent & Trademark Office, the disclosure of which is incorporated by reference herein in its entirety.

### BACKGROUND

### 1. Field

The disclosure relates to image editing, and more particularly to the automatic creation of datasets which may be used to train models related to instruction-guided image editing, and to perform and evaluate instruction-guided image editing.

### 2. Description of Related Art

Instruction-guided image editing may refer to a process which allows a user to edit images using intuitive instructions. With these developments, the need for effective automated evaluation methods has become increasingly important. May existing approaches to image evaluation may rely on metrics such as mean squared error (MSE), peak signal-to-noise ratio (PSNR), structural similarity index measure (SSIM), and learned perceptual image patch similarity (LPIPS). Other approaches may leverage large vision models, including the Contrastive Language-Image Pre-training (CLIP) model and the Distillation with NO labels (DINO) model, introducing metrics such as CLIP score, CLIP similarity, CLIP directional similarity, and DINO similarity. Metrics such as CLIP similarity and DINO similarity may solely rely on ground-truth outputs from image editing benchmarks, and may overlook textual information. While CLIP score and CLIP directional similarity may incorporate both text and images, they may be limited to image descriptions and prompts rather than editing instructions. Additionally, the CLIP text model may have limitations including difficulties with long text understanding and a limited understanding of compositional relationships among objects and attributes, which may reduce its robustness for evaluation tasks. Other approaches have used vision-language models (VLMs) as judges, such as VIEScore and GenAI-Bench, leveraging their abilities to process long text and images jointly with richer semantic understanding. However, open-source VLMs may struggle to align with human judgment, likely due to limitations in training data and computational resources. While proprietary models such as ChatGPT and Gemini may provide higher performance, they lack transparency, customizability, and cost efficiency.

One possible obstacle in developing a robust image editing scorer or image editing evaluation model is acquiring suitable training data. Some approaches rely on human-annotated ground-truth labels, which may be costly to generate or obtain, and therefore may limit dataset scalability. Other approaches may use proprietary models to generate labels, but this may be expensive for large-scale datasets and may inherently constrain fine-tuned VLM performance to that of the proprietary models.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method for training an editing evaluation model includes: obtaining a reference image and an editing instruction for editing the reference image; obtaining an edited image corresponding to the reference image and the editing instruction; providing the reference image, the editing instruction, and the edited image to an artificial intelligence (AI) editing evaluation model to obtain an editing evaluation score; and modifying at least one parameter of the editing evaluation model based on a comparison between the editing evaluation score and a ground truth editing evaluation score corresponding to the reference image, the editing instruction, and the edited image.

The editing instruction may be expressed in a natural language format.

The editing evaluation model may include at least one of a vision language model (VLM), a low-rank adaptation (LoRA) model, and a decoder model.

The reference image and the edited image may be obtained from a multi-turn image editing sequence, and the multi-turn image editing sequence may include the reference image, a plurality of sequential edited images corresponding to a plurality of sequential editing instructions, and a final edited image.

The editing instruction may be obtained based on one or more sequential editing instructions from among the plurality of sequential editing instructions, the edited image may include a sequential edited image that is generated based on the one or more sequential editing instructions, and the ground truth editing evaluation score may be obtained by performing linear interpolation based on the one or more sequential editing instructions.

The method may further include: obtaining a training image corresponding to the reference image and the editing instruction using a pre-trained image editing model; and performing a fine-tuning training operation based on a comparison between the training image and the edited image to obtain a fine-tuned image editing model.

The fine-tuning training operation may include: appending a reward instruction to the editing instruction to obtain a reward-conditioned editing instruction, wherein the reward instruction corresponds to the editing evaluation score; providing the reference image and the reward-conditioned editing instruction to the pre-trained image editing model to obtain the training image; and obtaining the fine-tuned image editing model by modifying at least one parameter of the pre-trained image editing model based on the comparison between the training image and the edited image.

The method may further include: obtaining a new reference image and a new editing instruction for editing the new reference image; appending a maximum reward instruction to the editing instruction to obtain a new reward-conditioned editing instruction; and providing the new reference image and the new reward-conditioned editing instruction to the pre-trained image editing model to obtain an output image.

In accordance with an aspect of the disclosure, an electronic device for training an editing evaluation model includes: at least one memory configured to store instructions; and at least one processor configured to execute the instructions to: obtain a reference image and an editing instruction for editing the reference image; obtain an edited image corresponding to the reference image and the editing instruction; provide the reference image, the editing instruction, and the edited image to an artificial intelligence (AI) editing evaluation model to obtain an editing evaluation score; and modify at least one parameter of the editing evaluation model based on a comparison between the editing evaluation score and a ground truth editing evaluation score corresponding to the reference image, the editing instruction, and the edited image.

The editing instruction may be expressed in a natural language format.

The editing evaluation model may include at least one of a VLM, a LoRA model, and a decoder model.

The reference image and the edited image may be obtained from a multi-turn image editing sequence, and the multi-turn image editing sequence may include the reference image, a plurality of sequential edited images corresponding to a plurality of sequential editing instructions, and a final edited image.

The editing instruction may be obtained based on one or more sequential editing instructions from among the plurality of sequential editing instructions, the edited image may include a sequential edited image that is generated based on the one or more sequential editing instructions, and the ground truth editing evaluation score may be obtained by performing linear interpolation based on the one or more sequential editing instructions.

The at least one processor may be further configured to execute the instructions to: obtain a training image corresponding to the reference image and the editing instruction using a pre-trained image editing model; and perform a fine-tuning training operation based on a comparison between the training image and the edited image to obtain a fine-tuned image editing model.

To perform the fine-tuning training operation, the at least one processor may be further configured to execute the instructions to: append a reward instruction to the editing instruction to obtain a reward-conditioned editing instruction, wherein the reward instruction corresponds to the editing evaluation score; and provide the reference image and the reward-conditioned editing instruction to the pre-trained image editing model to obtain the training image; and obtain the fine-tuned image editing model by modifying at least one parameter of the pre-trained image editing model based on the comparison between the training image and the edited image.

The at least one processor may be further configured to execute the instructions to: obtain a new reference image and a new editing instruction for editing the new reference image; append a maximum reward instruction to the editing instruction to obtain a new reward-conditioned editing instruction; and provide the new reference image and the new reward-conditioned editing instruction to the pre-trained image editing model to obtain an output image.

In accordance with an aspect of the disclosure, a non-transitory computer-readable medium storing instructions which, when executed by at least one processor of a device for training an image restoration model, cause the device to: obtain a reference image and an editing instruction for editing the reference image; obtain an edited image corresponding to the reference image and the editing instruction; provide the reference image, the editing instruction, and the edited image to an artificial intelligence (AI) editing evaluation model to obtain an editing evaluation score; and modify at least one parameter of the editing evaluation model based on a comparison between the editing evaluation score and a ground truth editing evaluation score corresponding to the reference image, the editing instruction, and the edited image.

The reference image and the edited image may be obtained from a multi-turn image editing sequence, the multi-turn image editing sequence may include the reference image, a plurality of sequential edited images corresponding to a plurality of sequential editing instructions, and a final edited image, the editing instruction may be obtained based on one or more sequential editing instructions from among the plurality of sequential editing instructions, the edited image may include a sequential edited image that is generated based on the one or more sequential editing instructions, and the ground truth editing evaluation score may be obtained by performing linear interpolation based on the one or more sequential editing instructions.

The at least one processor may be further configured to execute the instructions to: obtain a training image corresponding to the reference image and the editing instruction using a pre-trained image editing model; append a reward instruction to the editing instruction to obtain a reward-conditioned editing instruction, wherein the reward instruction corresponds to the editing evaluation score; and provide the reference image and the reward-conditioned editing instruction to the pre-trained image editing model to obtain the training image; and obtain a fine-tuned image editing model by modifying at least one parameter of the pre-trained image editing model based on the comparison between the training image and the edited image.

The at least one processor may be further configured to execute the instructions to: obtain a new reference image and a new editing instruction for editing the new reference image; append a maximum reward instruction to the editing instruction to obtain a new reward-conditioned editing instruction; and provide the new reference image and the new reward-conditioned editing instruction to the pre-trained image editing model to obtain an output image.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of an electronic device for performing and evaluating image editing, according to embodiments;

FIG. 2 is a diagram showing an example operation of an image editing model, according to embodiments;

FIG. 3 is a diagram showing an example operation of an editing evaluation model, according to embodiments;

FIGS. 4A-4C area a diagrams showing example operations of a training data generation module, according to embodiments;

FIG. 5A is a diagram showing an example of a process for training an editing evaluation model;

FIG. 5B is a diagram showing an example operation of an editing evaluation model, according to embodiments;

FIG. 6A is a diagram showing an example operation of a reward-conditioned image editing model, according to embodiments;

FIG. 6B is a diagram showing an example of a process for training a reward-conditioned image editing model;

FIGS. 7A-7C are flowcharts of processes for performing and evaluating image editing, according to embodiments; and

FIG. 8 is a block diagram of an electronic device according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As discussed above, advances in instruction-guided image editing underscore the need for effective automated evaluation. While vision-language models (VLMs) have been explored as judges, open-source models struggle with alignment, and proprietary models lack transparency and cost efficiency. Additionally, no public training datasets exist to fine-tune open-source VLMs, only small benchmarks with disparate evaluation schemes.

Therefore, embodiments may provide automated dataset creation approaches for training an image editing evaluation model for evaluating edited images that are obtained using instruction-guided image editing. For example, embodiments may leverage text-guided image editing models to generate outputs using samples from instruction-guided training datasets, which may generate evaluation scores automatically using a predetermined set of heuristics. As another example, embodiments may incorporate multi-turn edit sequences and assign evaluation scores to any sample within a sequence automatically.

Embodiments may enable the creation of large-scale image editing evaluation datasets, and may facilitate the training of open-source VLMs as image editing evaluation models. These trained image editing evaluation models may serve as reliable automated evaluation metrics and function as reward models to improve image editing systems, benefiting applications such as image editing features in image gallery programs included in electronic devices such as mobile devices, personal computers, tablet computers, augmented reality (AR) devices, virtual reality (VR) devices, and televisions, but embodiments are not limited thereto.

Accordingly, embodiments may relate to a process for generating an editing evaluation training dataset by automatically generating evaluation scores for image editing pairs. In addition, embodiments may relate to a process for training an editing evaluation model using the generated editing evaluation training dataset. Further, embodiments may relate to using the editing evaluation model to generate reward information that may be used to train or fine-tune an image editing model to provide improved image editing performance.

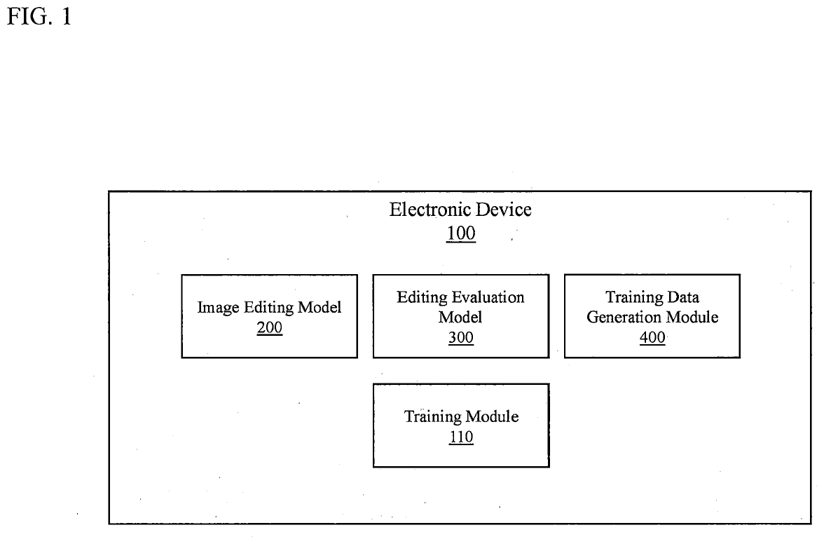

FIG. 1 is a diagram showing a general overview of an electronic device for performing and evaluating image editing, according to embodiments.

As shown in FIG. 1, an electronic device 100 may include an image editing model 200, an editing evaluation model 300, a training data generation module 400, and a training module 110, but embodiments are not limited thereto.

According to embodiments, the image editing model 200 may be a machine learning, artificial intelligence, and/or neural network model which may be used to perform image editing tasks. In some embodiments, the image editing model 200 may be an instruction-guided image editing model, which may perform the image editing tasks based on editing instructions (e.g., text instructions, natural language instructions, and/or intuitive instructions) received from a user.

According to embodiments, the editing evaluation model 300 may be machine learning, artificial intelligence, and/or neural network model which may be configured to generate editing evaluation scores based associated with edited images. In some embodiments, the editing evaluation model 300 may receive as input a reference image, an editing instruction, and an edited image corresponding to the reference image and the editing instruction, and may output an editing evaluation score. In some embodiments, this editing evaluation score may be used to perform fine-tuning training on the image editing model 200, or a similar image editing model.

According to embodiments, the training data generation module 400 may be configured to automatically generate training data which may be included in an editing evaluation training dataset. In some embodiments, the editing evaluation training dataset may include a plurality of entries, and each entry may include, for example, a reference image, an editing instruction, an edited image corresponding to the reference image and the editing instruction, and a ground truth editing evaluation score. In some embodiments, the image editing evaluation dataset may be used by the training module 110 to perform training operations.

According to embodiments, the training module 110 may be configured to train machine learning, artificial intelligence, and/or neural network models or architectures included in the electronic device 100, for example models included in at least one from among the image editing model 200, the editing evaluation model 300, and the training data generation module 400. In embodiments, a neural network may refer to a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network may refer to a hardware or a software component that includes a number of connected nodes (e.g., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module 110, to improve the accuracy of the result (e.g., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer is known as the output layer. In some embodiments, signals may traverse certain layers multiple times. In embodiments, at least one of the weights and thresholds may be referred to as model parameters.

In embodiments, at least one machine learning model, artificial intelligence model, or neural network model included in the image editing model 200, the editing evaluation model 300, or the training data generation module 400 may be, or may include, at least one of an artificial neural network, a convolutional neural network (CNN), a transformer model, a Generative Adversarial Network (GAN), a U-Net model, an autoencoder (AE) model, a vision language model (VLM), a low-rank adaptation (LoRA) model, a decoder, etc., which may be trained using the training module 110. However, embodiments are not limited thereto.

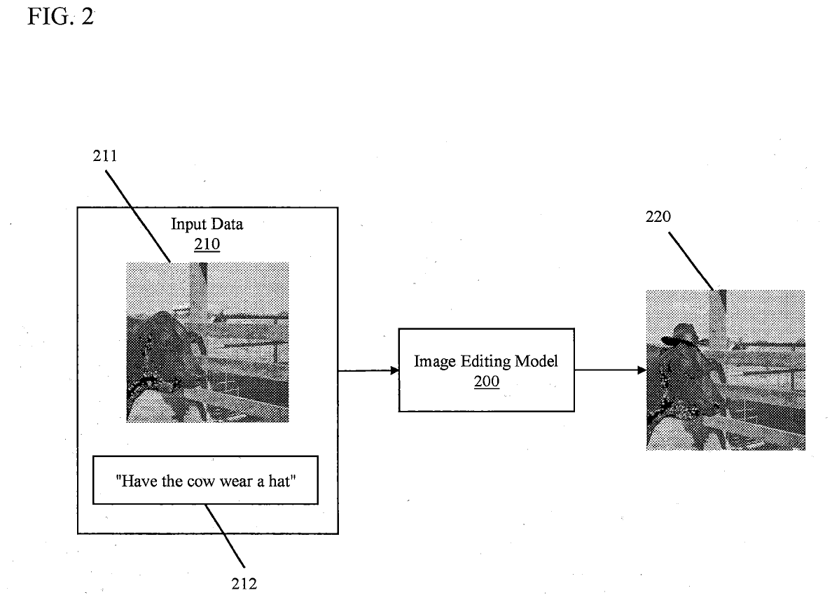

FIG. 2 is a diagram showing an example operation of an image editing model, according to embodiments.

According to embodiments, the image editing model 200 may be configured to receive input data 210, which may include a reference image 211 and an editing instruction, and to output an edited image that is edited based on the editing instruction. In some embodiments, the image editing model 200 may be, or may include, an instruction-guided image editing model which may be configured to edit the content of an image based on a natural language or text instruction received from a user. An instruction-guided image editing model may not require users to possess specific image editing skills, and instead may make semantic edits (e.g., object manipulation, color change, style change, etc.) based on the natural language or text instruction. For example, as shown in FIG. 2, the reference image 211 may include an image of a cow, the editing instruction may specify “Have the cow wear a hat”, and the edited image 220 may be similar to the reference image 211, with edits or modifications so that a hat appears on the head of the cow. However, this is only an example, and embodiments are not limited thereto.

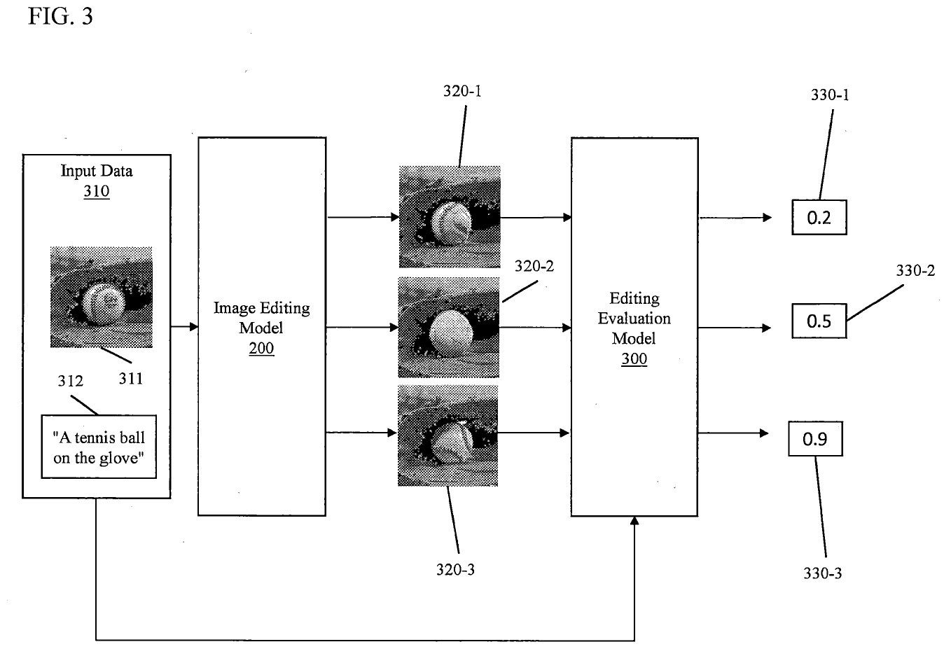

FIG. 3 is a diagram showing an example operation of an editing evaluation model, according to embodiments.

Image editing models may not always generate perfect results, and may sometimes suffer from issues such as identity preservation, instruction misunderstanding, etc. To improve image editing results, it may be beneficial to use high quality image editing training datasets to train image editing models, and it may be beneficial to include editing evaluation scores in the image editing training datasets to enable efficient and effective training. In some embodiments, the editing evaluation model 300 may be used to generate editing evaluation scores which may be used in these image editing training datasets.

As shown in FIG. 3, the image editing model 200 may receive input data 310, which may include a reference image 311 and an editing instruction 312, and may generate a plurality of edited images 320 which may have different levels of editing quality. In embodiments, the editing quality of an edited image 320 may be referred to as an editing quality level, and may indicate how successfully the editing instruction 312 was executed on the reference image 311 to generate the edited image 320. In embodiments, the editing quality may relate to, for example, object manipulation, color change, style change, etc. For example, the plurality of edited images 320 may include a first edited image 320-1 having a first editing quality, a second edited image 320-2 having a second editing quality, and a third edited image 320-3 having a third editing quality.

The editing evaluation model 300 may receive as input the reference image 311, the editing instruction 312, the plurality of edited images 320, and may generate a plurality of editing evaluation scores 330. For example, the editing evaluation model 300 may generate a first editing evaluation score 330-1 based on the reference image 311, the editing instruction 312, and the first edited image 320-1. Similarly, the editing evaluation model 300 may generate a second editing evaluation score 330-2 based on the reference image 311, the editing instruction 312, and the second edited image 320-2, and may generate a third editing evaluation score 330-3 based on the reference image 311, the editing instruction 312, and the third edited image 320-3. As shown in FIG. 3, the plurality of editing evaluation scores 330 may be different from each other, which may reflect the differing editing quality levels of the plurality of edited images 320.

As discussed above, when training image editing models, it may be beneficial to use image editing training datasets which include editing evaluation scores. In order to obtain these editing evaluation scores, an automatic evaluator may be used to measure the editing quality of the edited images. However, some automatic image editing evaluation metrics such as FID and CLIPScore may not be designed for image editing tasks, and therefore may not align with human preferences. Human-rated image editing evaluation scores may be used to tune image editing models to align the model outputs with human preferences, but it may be time-consuming and expensive to obtain the human ratings. Therefore, the editing evaluation model 300 may be trained to generate editing evaluation scores which are aligned with human preferences, or any other preferences as desired. According to embodiments, the human-aligned automatic editing evaluation model 300 may reduce human rating labor to scale up model training.

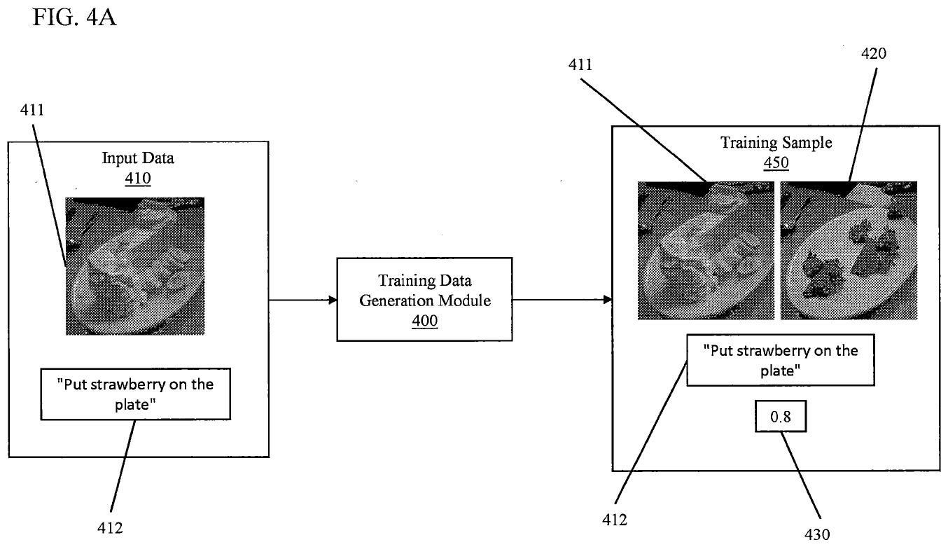

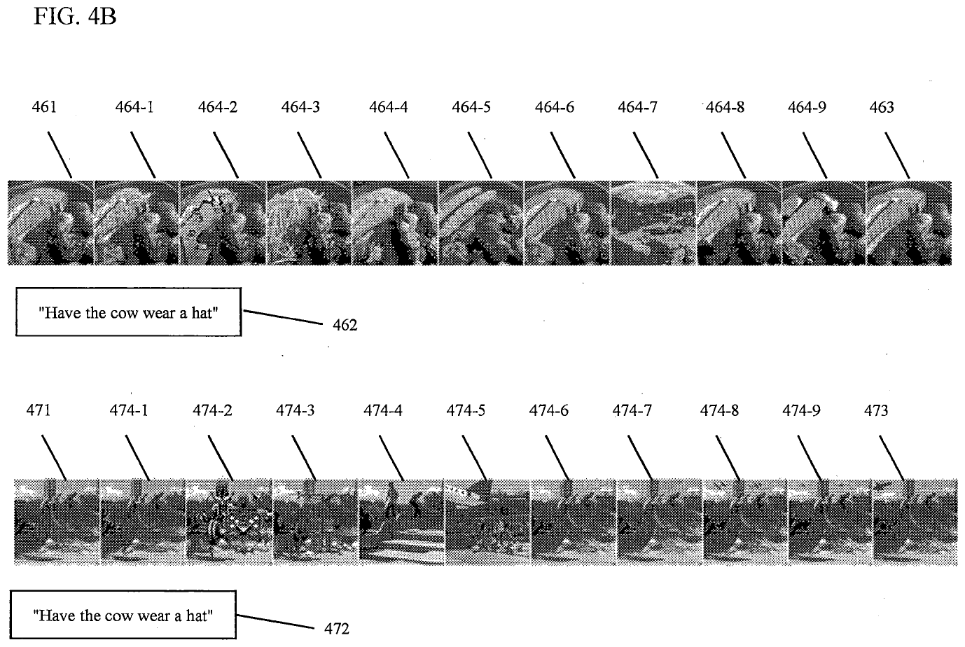

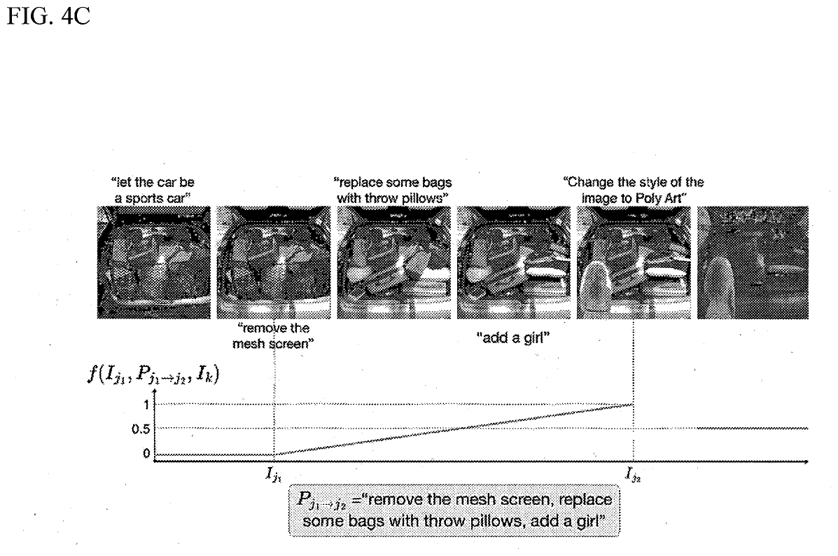

FIGS. 4A-4C are diagrams showing example operations of a training data generation module, according to embodiments.

In some embodiments, the training data generation module 400 may be configured to generate an editing evaluation training dataset which may be used to train the editing evaluation model 300. As shown in FIG. 4A, the training data generation module 400 may receive input data 410 which may include a reference image 411 and an editing instruction 412. Based on the input data 410, the training data generation module 400 may generate a corresponding training sample 450. In embodiments, the training sample 450 may include the reference image 411, the editing instruction 412, an edited image 420 which may correspond to the reference image 411 and the editing instruction 412, and a ground truth editing evaluation score 430, which may indicate how successfully the editing instruction 412 was executed on the reference image 411 to generate the edited image 420. In embodiments, the example training sample 450 shown in FIG. 4A may be a sample or entry from among a plurality of samples or entries included in an editing evaluation training dataset which may be used to train the editing evaluation model 300.

According to embodiments, the training data generation module 400 may generate the training dataset by leveraging resources from the image editing space, including instruction-guided training datasets and text-guided image editing models. For example, the characteristics of some image editing training datasets (e.g., may be useful when generating an editing evaluation training dataset. These image editing training datasets may contain two distinct sample types: (1) ground-truth edited images, which may represent successful edits with high editing evaluation scores, and (2) input images, which, along with their augmented versions, should receive low editing evaluation scores if treated as edited images, because the corresponding editing instructions are not yet successfully executed. To introduce more sample diversity, additional outputs may be generated using text-guided image editing models, and heuristics may be applied to assign corresponding editing evaluation scores. Additionally, multi-turn image editing datasets may be incorporated as an auxiliary training signal. For example, intermediate edited images within a multi-turn image editing sequence may provide incorrect or partially correct results with varying evaluation scores relative to the final edited image.

Using these approaches, embodiments may be used to construct large-scale instruction-guided editing evaluation training datasets which may be used to train the editing evaluation model 300. Furthermore, this editing evaluation model 300 may function as a reward model to enhance image editing models by conditioning training on editing quality scores predicted by the editing evaluation model 300.

FIG. 4B shows examples of images which may be used to generate training samples 450 using image editing techniques. First, a reference image, an editing instruction, and a ground truth edited image may be obtained, and one or more instruction-guided image editing processes may be used to generate one or more edited images. In embodiments, the instruction-guided image editing processes may include, for example, models such as a CycleDiffusion model, a DiffEdit model, a Prompt-to-Prompt model, a Pix2Pix-Zero model, an SDEdit model, a Text2LIVE model, an InstructPix2Pix model, MagicBrush model, and an AURORA model.

For example, as shown in FIG. 4B, a reference image 461, an editing instruction 462, and a ground truth edited image 463 may be obtained, and a plurality of edited images 464 may be generated using the reference image 461 and the editing instruction 462. For example, the edited image 464-1 may be generated using the CycleDiffusion model, the edited image 464-2 may be generated using the DiffEdit model, the edited image 464-3 may be generated using the Prompt-to-Prompt model, the edited image 464-4 may be generated using the Pix2Pix-Zero model, the edited image 464-5 may be generated using the SDEdit model, the edited image 464-6 may be generated using the Text2LIVE model, the edited image 464-7 may be generated using the InstructPix2Pix model, the edited image 464-8 may be generated using the MagicBrush model, and the edited image 464-9 may be generated using the AURORA model, but embodiments are not limited thereto. Similarly, a reference image 471, an editing instruction 472, and a ground truth edited image 473 may be obtained, and a plurality of edited images 474 may be generated using the reference image 471 and the editing instruction 472. For example, the edited image 474-1 may be generated using the CycleDiffusion model, the edited image 474-2 may be generated using the DiffEdit model, the edited image 474-3 may be generated using the Prompt-to-Prompt model, the edited image 474-4 may be generated using the Pix2Pix-Zero model, the edited image 474-5 may be generated using the SDEdit model, the edited image 474-6 may be generated using the Text2LIVE model, the edited image 474-7 may be generated using the InstructPix2Pix model, the edited image 474-8 may be generated using the MagicBrush model, and the edited image 474-9 may be generated using the AURORA model, but embodiments are not limited thereto.

Next, an editing evaluation score may be generated for each of the edited images. In embodiments, a training sample corresponding to a failed edit may be referred to as a negative sample, and a training sample corresponding to a successful or partially successful edit may be referred to as a positive sample. In embodiments, negative samples may be assigned an editing evaluation score of 0, positive samples may be assigned an editing evaluation score of 0.5 for partially successful edits and an editing evaluation score of 1 for successful edits, but embodiments are not limited thereto.

In some embodiments, training samples that include edited images generated using models known to produce lower-quality edits (e.g., the DiffEdit model, the Pix2Pix-Zero model, the SDEdit model, and Text2LIVE model) may be used as negative samples. In addition, training samples in which the reference image is used as the edited image may also be used as negative samples, because these represent cases in which no edit has occurred despite the editing instruction.

In addition, other rules may be used to identify negative samples. In some embodiments, negative samples may be identified by measuring image similarity between the reference image and the edited image. As an example, a Contrastive Language-Image Pre-training (CLIP) model and a Distillation with NO labels (DINO) model may be used to calculate a CLIP image similarity score (CLIP-I score) and a DINO image similarity score (DINO-I score) for each input image and the 5^{th} percentile score for each metric may be set as thresholds τ_{CLIP-I} and τ_{DINO-I}. Training samples for which CLIP-I≤τ_{CLIP-I} and DINO-I≤τ_{DINO-I} may be identified as negative samples, and assigned an editing evaluation score of 0.

As another example, the CLIP model may be used to calculate CLIP text-image direction similarity score (CLIP-D score), and training samples for which CLIP-D<=0 may be identified as negative samples, and assigned an editing evaluation score of 0.

In some embodiments, training samples that include edited images generated using models known to produce higher-quality edits (e.g., the MagicBrush model and the AURORA model) may be used as positive samples. For example, a CLIP-D threshold score of 0.2 may be applied to distinguish successful edits (which may be assigned an editing evaluation score of 0) from partially successful edits.

FIG. 4C shows examples of images which may be used to generate training samples 450 using a multi-turn image editing sequence. In embodiments, a multi-turn image editing sequence may refer to a sequence of images in which successive edits are applied to the same image. According to embodiments, any image in the sequence of images may serve as a ground-truth edited image for any preceding image, given the corresponding editing instructions. This may enable a systematic construction of training samples for the editing evaluation training dataset.

As shown in FIG. 4C, an image editing sequence may be denoted as S=[I₀, p₁, I₁, . . . , pₜ, Iᵢ] with I edit turns, where the jth edit turn (j∈[1,l]) corresponds to performing the editing instruction pⱼ on the reference image Iⱼ₋₁ to produce the edited image Iⱼ. To generate training samples, we two images Iⱼ, Iⱼ₂∈S may be randomly sampled where j₁<j₂. These two images may be treated as the reference image and the ground-truth edited image, with the corresponding editing instruction defined as Pⱼ_{₁}_{→j}_{₂}={pⱼ|j∈[j₁,j₂−1]}. The editing quality of any edited image Tk E S with respect to the reference image Iⱼ₋₁ and the editing instruction Pⱼ_{₁}_{→j}_{₂} may be categorized into one of four cases below.

For example, when k∈[1,j₁], the edited image I_{K} may be either the reference image itself or an image from an earlier editing turn. None of the changes from Iⱼ_{₁} k to Iₖ may align with the editing instruction Pⱼ_{₁}_{→j}_{₂} which may indicate a failure to execute the editing instruction, and therefore may be assigned an editing evaluation score of 0.

When k∈[j₁+1,j₂−1], the edited image I_{K} may correspond to an intermediate editing turn between Iⱼ_{₁} and Iⱼ_{₂}. Editing instructions {pₖ|k∈[j₁,k−1]} may have been successfully executed, while editing instructions {pⱼ|j∈[k,j₂−1]} may remain incomplete. If the level of success is assumed to be directly proportional to the number of editing instructions that have been successfully executed, then the editing evaluation score may be expressed as

$$\frac{k - {j}_{1}}{{j}_{2} - {j}_{1}} .$$

If k=j₂, the ground-truth edited image is selected, which may correspond to a fully successful edit, and therefore may be assigned an editing evaluation score of 1. Further, when k∈[j₂+1,l], all editing instructions in Pⱼ_{₁}_{→j}_{₂} may have been successfully executed, and then additional irrelevant instructions {pⱼ|j∈[j₂+1,k]} may have also been executed. Because it may be difficult to automatically evaluate the level of negative effect of excessive editing instruction on the editing quality, the over-edited images may be assigned an editing evaluation score of 0.5.

Therefore, according to embodiments, an editing evaluation score assignment function for an edited image Iₖ with respect to the reference image Iⱼ_{₁} and editing instruction Pⱼ_{₁}_{→j}_{₂} may be expressed according to Equation 1 below:

$$f ( {I}_{{j}_{1}} , {P}_{{j}_{1} \to {j}_{2}} , {I}_{k} ) = \{ \begin{matrix}0 & if k ∈ [ 1 , {j}_{1} ) , \\ \frac{k - {j}_{1}}{{j}_{2} - {j}_{1}} & if k ∈ [ {j}_{1} , {j}_{2} ] , \\ 0.5 & if k ∈ ( {j}_{2} , l ] .\end{matrix} \qquad ( Equation 1 )$$

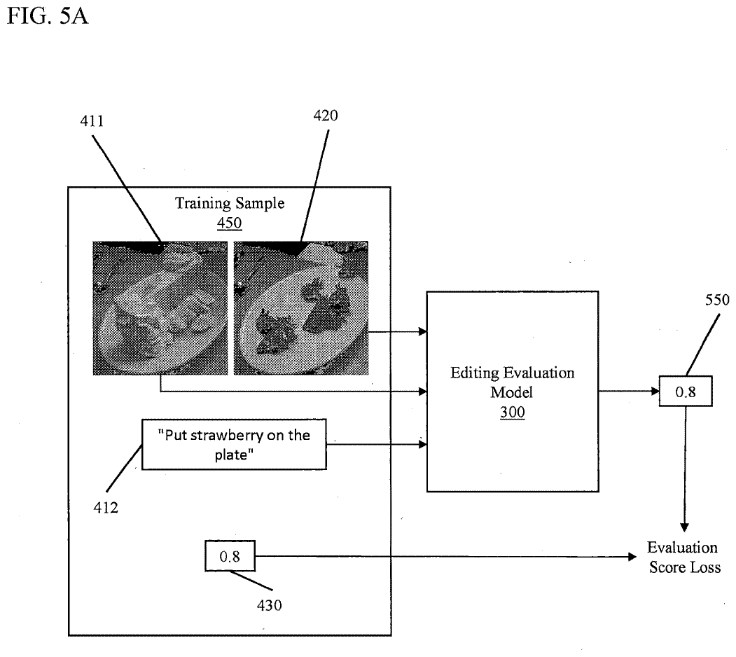

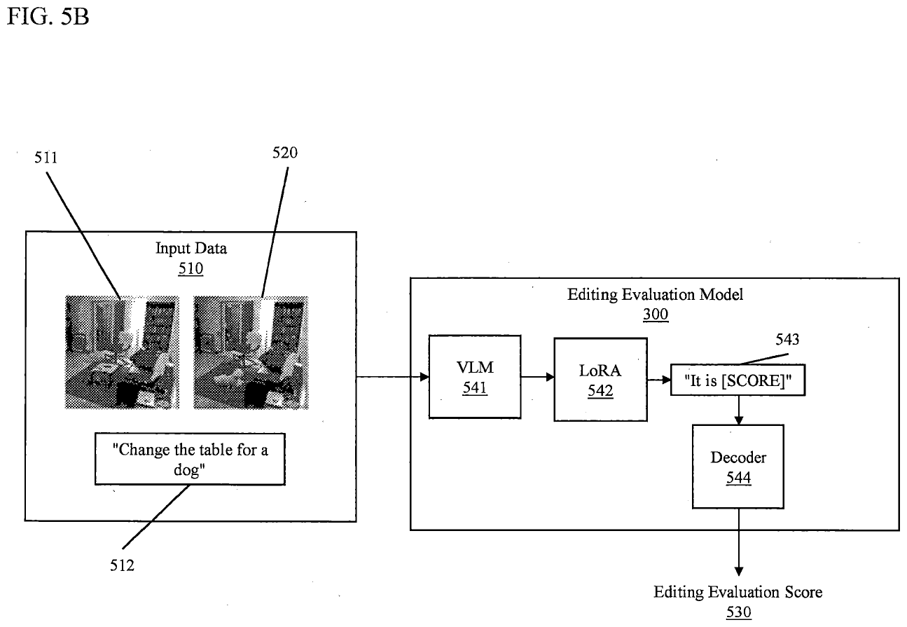

FIG. 5A is a diagram showing an example of a process for training an editing evaluation model.

According to embodiments, during a training operation which may be included in a training phase or a training stage of the editing evaluation model 300, at least a portion of data included in a training sample may be provided as input to the editing evaluation model 300, and the editing evaluation model 300 may generate an estimated editing evaluation score 550, which may also be referred to as a predicted editing evaluation score. Then, the estimated editing evaluation score 550 may be compared with a ground truth editing evaluation score to obtain an evaluation score loss, which may be used to modify one or more parameters (e.g., one or more weights or thresholds) of the editing evaluation model 300.

For example, as shown in FIG. 5A, the editing evaluation model 300 may receive as input the reference image 411, and edited image 420, and the editing instruction 412, and may generate the predicted editing evaluation score 550. Then, an evaluation score loss may be calculated based on the predicted editing evaluation score 550 and the ground truth editing evaluation score 430, and one or more parameters of the editing evaluation model 300 may be adjusted based on the evaluation score loss. According to embodiments, the editing evaluation score loss may be calculated based on a comparison between the predicted editing evaluation score 550 and the ground truth editing evaluation score 430. However, embodiments are not limited thereto, and the editing evaluation score loss may be calculated in any manner.

FIG. 5B is a diagram showing an example operation of an editing evaluation model, according to embodiments.

According to embodiments, after the editing evaluation model 300 is trained (e.g., after the training stage or training phase of the editing evaluation model 300, and during an inference stage or inference phase of the editing evaluation model 300), it may be used to assist in training other models, for example the image editing model 200. For example, the editing evaluation model 300 may receive input data 510, which may include a reference image 511, an edited image 520, and an editing instruction 512, and may output an editing evaluation score 530.

According to embodiments, the editing evaluation model 300 may be, or may include, one or more other models which may operate together to perform the functions of the editing evaluation model 300. For example, as shown in FIG. 5B, the editing evaluation model 300 may include a VLM 541, a LoRA model 542, and a decoder model 544. In some embodiments, the VLM 541 may be a model such as LLaVA-Next-8B, but embodiments are not limited thereto. Accordingly, the VLM 541 may be configured to process multiple relatively high-resolution images included in the input data 510. In addition, a vocabulary of the VLM 541 may be expanded with a special token [SCORE], which may be included in an intermediate result 543 generated by the LoRA model 542. In some embodiments, an embedding of the token [SCORE] may be decoded using the decoder model 544 to obtain the editing evaluation score 530 that is output by the editing evaluation model 300. In some embodiments, the input to the VLM 541 may be a prompt generated based on the editing instruction 512. For example, the prompt provided as input to the VLM 541 may be a natural language prompt such as “How successful was the editing instruction “Change the table for a dog” executed from the first image to the second image?”, but embodiments are not limited thereto.

According to embodiments, an output of the editing evaluation model 300 (e.g., the editing evaluation score 530) may be used to perform a training operation for an imaging editing model. For example, as discussed above, an example of which is described in greater detail below.

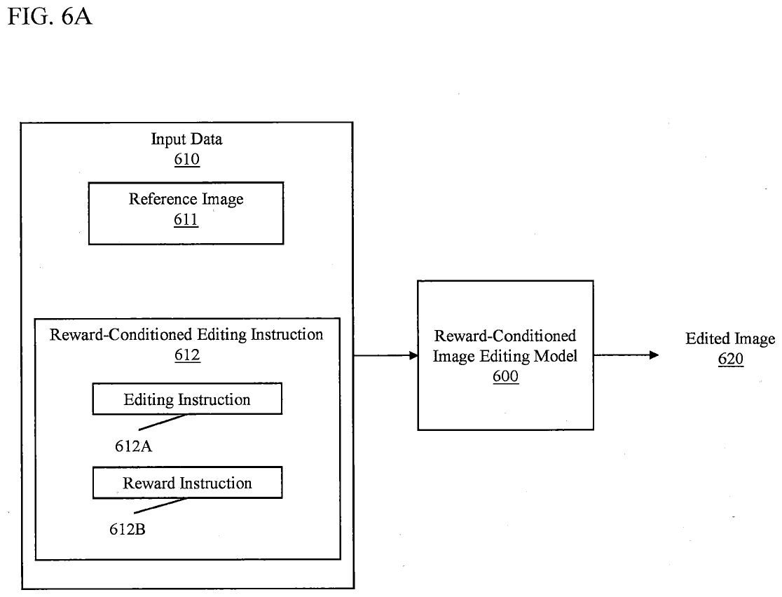

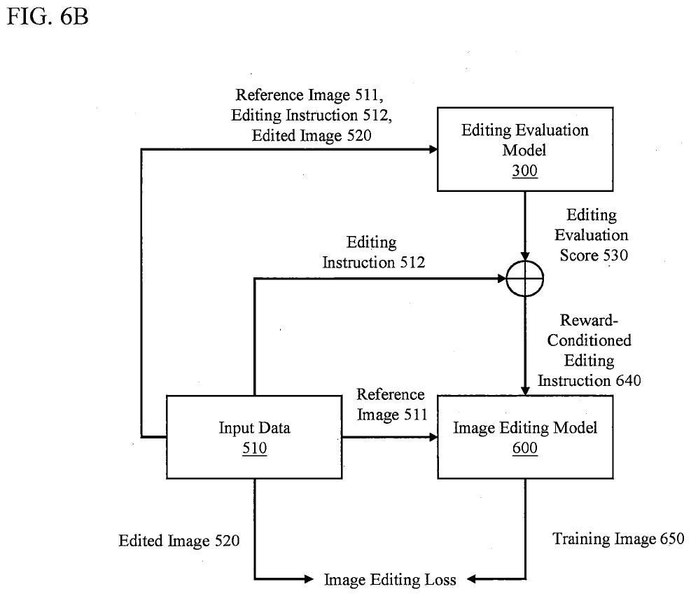

FIG. 6A is a diagram showing an example operation of a reward-conditioned image editing model.

According to embodiments, an image editing model 600 may be similar to the image editing model 200 discussed above, except that an input to the image editing model 600 may additionally include a reward instruction. Accordingly, the image editing model 600 may be referred to as a reward-conditioned image editing model, but embodiments are not limited thereto. In embodiments, the image editing model may be included in the electronic device 100 instead of, or in addition to, the image editing model 200, and may be trained by the training module 110. For example, as shown in FIG. 6A, the image editing model 600 may receive input data which may include a reference image 611 and a reward-conditioned editing instruction 612. In embodiments, the reward-conditioned editing instruction 612 may include an editing instruction 612A and a reward instruction 612B. In some embodiments, the reference image 611 may be correspond to the reference image 211, the reference image 311, the reference image 411, and the reference image 511 discussed above, and the editing instruction may be similar to the editing instruction 212, the editing instruction 312, the editing instruction 412, and the editing instruction 512 discussed above, but embodiments are not limited thereto.

The image editing model 600 may be configured to generate an edited image 620 based on the input data 610. For example, the edited image 620 may be generated by editing or modifying the reference image 611 by executing the editing instruction 612A according to one or more conditions associated with the reward instruction 612B. For example, in some embodiments, the reward instruction 612B may include, or may be generated based on, an editing evaluation score. For example, the reward instruction may be, or may include, a text prompt which states “The image quality is [SCORE] out of five”, but embodiments are not limited thereto. Accordingly, the image editing model 600 may generate the edited image 620 by executing the editing instruction 612A on the reference image 611 in such a way that the edited image 620 may be assigned an editing evaluation score that corresponds to the reward instruction 612B.

As discussed above, the editing evaluation model 300 may function as a reward model to enhance image editing models such as the image editing model 600, by conditioning the training of the image editing model 600 on editing quality scores that are predicted or estimated by the editing evaluation model 300. Accordingly, during a training phase or training stage of the image editing model 600, the reward instruction 612B may be similar to, or may be obtained based on, the editing evaluation score 530 discussed above, but embodiments are not limited thereto.

FIG. 6B shows an example of a process for training the reward-conditioned image editing model, according to embodiments.

During a training operation which may be included in a training stage or training phase of the image editing model 600, an input including the reference image 511, the editing instruction 512, and the edited image 520 may be provided to the editing evaluation model 300, which may generate the editing evaluation score 530. The editing evaluation score 530 (or information corresponding to the editing evaluation score 530) may be appended to the editing instruction 512 to obtain a reward-conditioned editing instruction 640. Then, the reference image 511 and the reward-conditioned editing instruction 640 may be provided as input to the image editing model 600, which may generate a training image 650. Then, an image editing loss may be calculated based on the training image 650 and the edited image 520, and one or more parameters of the image editing model 600 may be adjusted based on the evaluation score loss. According to embodiments, image editing loss may be calculated based on a comparison between the training image 650 and the edited image 520. However, embodiments are not limited thereto, and the image editing loss may be calculated in any manner. Accordingly, an inference stage or inference phase of the editing evaluation model 300 may correspond to a training stage or a training phase of the image editing model 600, but embodiments are not limited thereto.

In some embodiments, the training of the image editing model 600 may be referred to as fine-tuning training or a fine-tuning training operation of the image editing model 600. For example, before the training operation, the image editing model 600 may be a pre-trained image editing model 600, and the fine-tuning training operation may be performed on the pre-trained image editing model 600 to obtain a fine-tuned image editing model 600. In some embodiments, the pre-trained image editing model 600 may be trained using an image editing training dataset, and the fine-tuning training operation may be performed based on a fine-tuning training dataset which may be generated by providing the image editing training dataset to the editing evaluation model 300 to generate editing evaluation scores, and then appending the editing evaluation scores to the samples in the image editing training dataset. However, this is only an example, and embodiments are not limited thereto.

In some embodiments, after the fine-tuning training operation is performed (e.g., after a training phase or a training stage of the is completed), the fine-tuned image editing model 600 may be used to perform image editing tasks (e.g., at an inference phase or an inference stage of the fine-tuned image editing model 600). In order to perform the image editing tasks, the reward instruction 612B may be set to have a maximum score or maximum value to obtain a highest-quality edited image, but embodiments are not limited thereto.

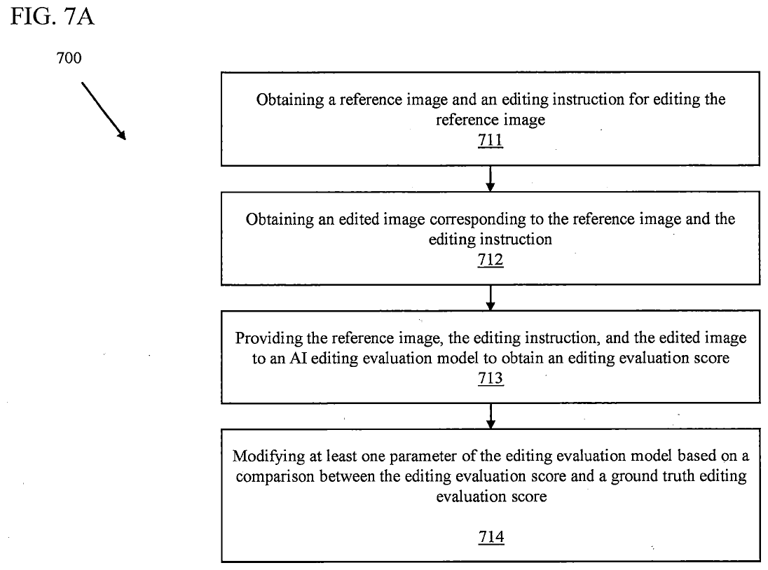

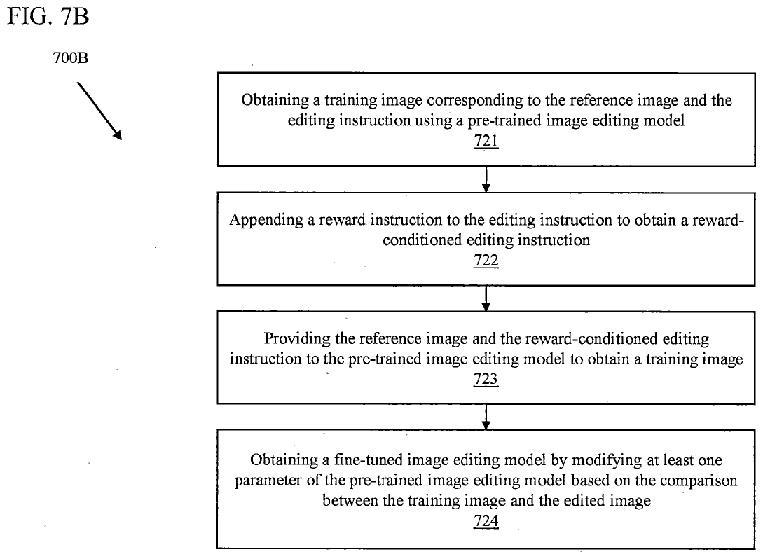

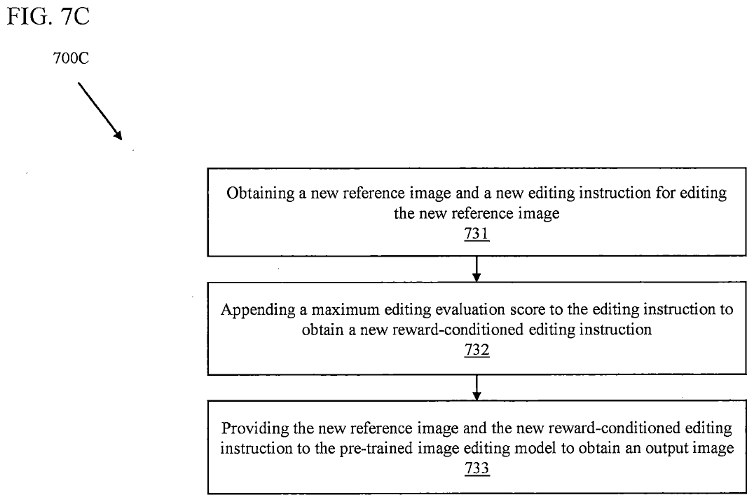

FIGS. 7A-7C are flowcharts of processes for performing and evaluating image editing, according to embodiments. According to embodiments, one or more operations illustrated in FIGS. 7A-7C may be performed using any of the elements discussed above, for example, at least one of the electronic device 100, the training module 110, the image editing model 200, the editing evaluation model 300, the training data generation module 400, the image editing model 600, and any of the elements included therein.

FIG. 7A is a flowchart of a process 700A for performing and evaluating image editing, according to embodiments. In some embodiments, one or more operations illustrated in FIG. 7A may be performed using one or more of the elements included in the electronic device 100, but embodiments are not limited thereto.

At operation 711, the process 700A may include obtaining a reference image and an editing instruction for editing the reference image.

At operation 712, the process 700A may further include obtaining an edited image corresponding to the reference image and the editing instruction.

At operation 713, the process 700A may further include providing the reference image, the editing instruction, and the edited image to an artificial intelligence (AI) editing evaluation model to obtain an editing evaluation score. In embodiments, the AI editing evaluation model may correspond to the editing evaluation model 300, but embodiments are not limited thereto.

At operation 714, the process 700A may further include modifying at least one parameter of the editing evaluation model based on a comparison between the editing evaluation score and a ground truth editing evaluation score corresponding to the reference image, the editing instruction, and the edited image.

In embodiments, the editing instruction may be expressed in a natural language format.

In embodiments, the editing evaluation model may include at least one of a VLM, a LoRA model, and a decoder model.

In embodiments, the reference image and the edited image may be obtained from a multi-turn image editing sequence, and the multi-turn image editing sequence may include the reference image, a plurality of sequential edited images corresponding to a plurality of sequential editing instructions, and a final edited image.

In embodiments, the editing instruction may be obtained based on one or more sequential editing instructions from among the plurality of sequential editing instructions, the edited image may include a sequential edited image that is generated based on the one or more sequential editing instructions, and the ground truth editing evaluation score may be obtained by performing linear interpolation based on the one or more sequential editing instructions.

FIG. 7B is a flowchart of a process 700B for performing and evaluating image editing. In some embodiments, one or more operations illustrated in FIG. 7B may be performed using one or more of the elements included in the electronic device 100, but embodiments are not limited thereto.

At operation 721, the process 700B may include obtaining a training image corresponding to the reference image and the editing instruction using a pre-trained image editing model. In embodiments, the pre-trained image editing model may correspond to the pre-trained image editing model 600, but embodiments are not limited thereto.

At operation 722, the process 700B may further include appending a reward instruction to the editing instruction to obtain a reward-conditioned editing instruction, wherein the reward instruction corresponds to the editing evaluation score.

At operation 723, the process 700B may further include providing the reference image and the reward-conditioned editing instruction to the pre-trained image editing model to obtain a training image.

At operation 724, the process 700B may further include obtaining the fine-tuned image editing model by modifying at least one parameter of the pre-trained image editing model based on the comparison between the training image and the edited image.

In embodiments, the process 700B may be referred to as a fine-tuning training operation or fine-tuning training process, which may be performed during a training phase or a training stage of the image editing model.

FIG. 7C is a flowchart of a process 700C for performing and evaluating image editing. In some embodiments, one or more operations illustrated in FIG. 7C may be performed using one or more of the elements included in the electronic device 100, but embodiments are not limited thereto.

At operation 731, the process 700C may include obtaining a new reference image and a new editing instruction for editing the new reference image.

At operation 732, the process 700C may further include appending a maximum reward instruction to the editing instruction to obtain a new reward-conditioned editing instruction.

At operation 733, the process 700C may further include providing the new reference image and the new reward-conditioned editing instruction to the pre-trained image editing model to obtain an output image.

Although FIGS. 7A-7C show example blocks of processes 700A, 700B, and 700C, in some implementations, the processes 700A, 700B, and 700C may include additional blocks, fewer blocks, different blocks, or differently arranged blocks than those depicted in FIGS. 7A-7C. Additionally, or alternatively, two or more of the blocks of the processes 700A, 700B, and 700C may be arranged or combined in any order, or performed in parallel.

Therefore, embodiments may provide an automatic evaluation pipeline to provide editing quality feedback that aligns with human preferences to improve an instruction-guided image editing model. Embodiments may leverage resources from the image editing space and use novel approaches for automatically generating editing evaluation scores that can scale to generate datasets of appropriate size. Embodiments may provide a reliable automated evaluation metric for instruction-guided image editing, leveraging an editing evaluation model that may be trained or fine-tuned based on the generated editing evaluation data. Embodiments may use the editing evaluation model as a reward condition to further improve the image quality of an instruction-guided image editing model.

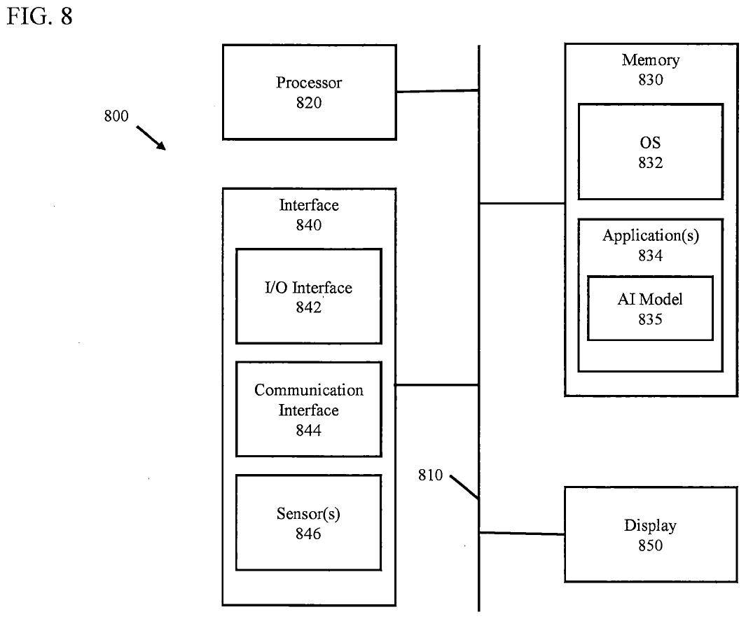

FIG. 8 is a block diagram of an electronic device according to embodiments

FIG. 8 is for illustration only, and other embodiments of the electronic device 800 could be used without departing from the scope of this disclosure. For example, the electronic device 800 may correspond to any combination of the electronic device 100 discussed above, and any of the components included therein.

The electronic device 800 includes a bus 810, a processor 820, a memory 830, an interface 840, and a display 850.

The bus 810 includes a circuit for connecting the components 820 to 850 with one another. The bus 810 functions as a communication system for transferring data between the components 820 to 850 or between electronic devices.

The processor 820 includes one or more of a central processing unit (CPU), a graphics processor unit (GPU), an accelerated processing unit (APU), a many integrated core (MIC), a field-programmable gate array (FPGA), or a digital signal processor (DSP). The processor 820 is able to perform control of any one or any combination of the other components of the electronic device 800, and/or perform an operation or data processing relating to communication. For example, the processor 820 may perform operations of the processes illustrated throughout the present disclosure, for example in FIGS. 7A-7C. The processor 820 executes one or more programs stored in the memory 830.

The memory 830 may include a volatile and/or non-volatile memory. The memory 830 stores information, such as one or more of commands, data, programs (one or more instructions), applications 834, etc., which are related to at least one other component of the electronic device 800 and for driving and controlling the electronic device 800. For example, commands and/or data may formulate an operating system (OS) 832. Information stored in the memory 830 may be executed by the processor 820.

The applications 834 include the above-discussed embodiments. These functions can be performed by a single application or by multiple applications that each carry out one or more of these functions. For example, the applications 834 may include one or more AI models for performing operations of the processes illustrated throughout the present disclosure, for example in FIGS. 7A-7C. Specifically, the applications 834 may include at least one of a training module, an image editing model, an editing evaluation model, a training data generation module, and a reward-conditioned image editing model, according to embodiments of the disclosure.

In some embodiments, functions related to AI are operated by the processor 820 and the memory 830. The processor 830 (may include or may correspond to a general-purpose processor, such as a CPU, an application processor, or a digital signal processor (DSP), a graphics-dedicated processor, such as a graphics processing unit (GPU) or a vision processing unit (VPU), or an artificial intelligence-dedicated processor, such as a neural processing unit (NPU). The processor 820 may control input data to be processed according to predefined operation rules or artificial intelligence models, which are stored in the memory 130. Alternatively, the processor 820 may be an artificial intelligence-dedicated processor including a hardware structure specialized for processing of a particular artificial intelligence model.

The predefined operation rules or the artificial intelligence models may be made through training. Here, the statement of being made through training means that a basic artificial intelligence model may be trained by a learning algorithm by using a large number of training data, thereby making a predefined operation rule or an artificial intelligence model, which is configured to perform a desired characteristic (or purpose). Such training may be performed in a device itself, in which artificial intelligence according to the disclosure is performed, or may be performed via a separate server or a separate system. Examples of the learning algorithm may include, but are not limited to, supervised learning, unsupervised learning, semi-supervised learning, and reinforcement learning.

The artificial intelligence model may include a plurality of neural network layers. Each of the plurality of neural network layers has a plurality of weight values and performs neural network calculations through calculations between a calculation result of a previous layer and the plurality of weight values. The plurality of weight values of the plurality of neural network layers may be optimized by a training result of the artificial intelligence model. For example, the plurality of weight values may be updated to minimize a loss value or a cost value, which is obtained from the artificial intelligence model during the process of training. An artificial neural network may include a DNN, and examples of the artificial neural network may include, but are not limited to, a random forest model, a convolutional neural network (CNN), a DNN, a recurrent neural network (RNN), a restricted Boltzmann machine (RBM), a deep belief network (DBN), a bidirectional recurrent deep neural network (BRDNN), and deep Q-Networks.

The display 850 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 840 includes input/output (I/O) interface 842, communication interface 844, and/or one or more sensors 846. The I/O interface 842 serves as an interface that can, for example, transfer commands and/or data between a user and/or other external devices and other component(s) of the electronic device 800.

The communication interface 844 may include a transceiver to enable communication between the electronic device 800 and other external devices (e.g., a sensor node or a fusion center), via a wired connection, a wireless connection, or a combination of wired and wireless connections. The communication interface 844 may permit the electronic device 800 to receive information from another device and/or provide information to another device. For example, the communication interface 844 may include an Ethernet interface, an optical interface, a coaxial interface, an infrared interface, a radio frequency (RF) interface, a universal serial bus (USB) interface, a Wi-Fi interface, a cellular network interface, or the like.

The transceiver of the communication interface 844 may include a radio frequency (RF) circuitry and a baseband circuitry.

The baseband circuitry may transmit and receive a signal through a wireless channel, and may perform band conversion and amplification on the signal. The RF circuitry may up-convert a baseband signal provided from the baseband circuitry into an RF band signal and then transmits the converted signal through an antenna, and down-converts an RF band signal received through the antenna into a baseband signal. For example, the RF circuitry may include a transmission filter, a reception filter, an amplifier, a mixer, an oscillator, a digital-to-analog converter (DAC), and an analog-to-digital converter (ADC).

The transceiver may be connected to one or more antennas. The RF circuitry of the transceiver may include a plurality of RF chains and may perform beamforming. For the beamforming, the RF circuitry may control a phase and a size of each of the signals transmitted and received through a plurality of antennas or antenna elements. The RF circuitry may perform a downlink multi-input and multi-output (MIMO) operation by transmitting one or more layers.

The baseband circuitry may perform conversion between a baseband signal and a bitstream according to a physical layer standard of the radio access technology. For example, when data is transmitted, the baseband circuitry generates complex symbols by encoding and modulating a transmission bitstream. When data is received, the baseband circuitry reconstructs a reception bitstream by demodulating and decoding a baseband signal provided from the RF circuitry.

The sensor(s) 846 of the interface 840 can meter a physical quantity or detect an activation state of the electronic device 800 and convert metered or detected information into an electrical signal. For example, the sensor(s) 846 can include one or more cameras or other imaging sensors for capturing images of scenes. The sensor(s) 846 can also include any one or any combination of a microphone, a keyboard, a mouse, and one or more buttons for touch input. The sensor(s) 846 can further include an inertial measurement unit. In addition, the sensor(s) 846 can include a control circuit for controlling at least one of the sensors included herein. Any of these sensor(s) 846 can be located within or coupled to the electronic device 800.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 800, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device 800.

A model related to the neural networks described above may be implemented via a software module. When the model is implemented via a software module (for example, a program module including instructions), the model may be stored in a computer-readable recording medium.

Also, the model may be a part of the electronic device 800 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method for performing image processing, the method comprising:
obtaining a reference image and an editing instruction for editing the reference image;
obtaining an edited image corresponding to the reference image and the editing instruction;
providing the reference image, the editing instruction, and the edited image to an artificial intelligence (AI) editing evaluation model to obtain an editing evaluation score; and
modifying at least one parameter of the editing evaluation model based on a comparison between the editing evaluation score and a ground truth editing evaluation score corresponding to the reference image, the editing instruction, and the edited image.

2. The method of claim 1, wherein the editing instruction is expressed in a natural language format.

3. The method of claim 1, wherein the editing evaluation model comprises at least one of a vision language model (VLM), a low-rank adaptation (LoRA) model, and a decoder model.

4. The method of claim 1, wherein the reference image and the edited image are obtained from a multi-turn image editing sequence, and wherein the multi-turn image editing sequence comprises the reference image, a plurality of sequential edited images corresponding to a plurality of sequential editing instructions, and a final edited image.

5. The method of claim 4, wherein the editing instruction is obtained based on one or more sequential editing instructions from among the plurality of sequential editing instructions,
wherein the edited image comprises a sequential edited image that is generated based on the one or more sequential editing instructions, and
wherein the ground truth editing evaluation score is obtained by performing linear interpolation based on the one or more sequential editing instructions.

6. The method of claim 1, further comprising:
obtaining a training image corresponding to the reference image and the editing instruction using a pre-trained image editing model; and
performing a fine-tuning training operation based on a comparison between the training image and the edited image to obtain a fine-tuned image editing model.

7. The method of claim 6, wherein the fine-tuning training operation comprises:
appending a reward instruction to the editing instruction to obtain a reward-conditioned editing instruction, wherein the reward instruction corresponds to the editing evaluation score;
providing the reference image and the reward-conditioned editing instruction to the pre-trained image editing model to obtain the training image; and
obtaining the fine-tuned image editing model by modifying at least one parameter of the pre-trained image editing model based on the comparison between the training image and the edited image.

8. The method of claim 7, further comprising:
obtaining a new reference image and a new editing instruction for editing the new reference image;
appending a maximum reward instruction to the editing instruction to obtain a new reward-conditioned editing instruction; and
providing the new reference image and the new reward-conditioned editing instruction to the pre-trained image editing model to obtain an output image.

9. An electronic device for performing image processing, the electronic device comprising:
at least one memory configured to store instructions; and
at least one processor configured to execute the instructions to:
obtain a reference image and an editing instruction for editing the reference image;
obtain an edited image corresponding to the reference image and the editing instruction;
provide the reference image, the editing instruction, and the edited image to an artificial intelligence (AI) editing evaluation model to obtain an editing evaluation score; and
modify at least one parameter of the editing evaluation model based on a comparison between the editing evaluation score and a ground truth editing evaluation score corresponding to the reference image, the editing instruction, and the edited image.

10. The electronic device of claim 9, wherein the editing instruction is expressed in a natural language format.

11. The electronic device of claim 9, wherein the editing evaluation model comprises at least one of a vision language model (VLM), a low-rank adaptation (LoRA) model, and a decoder model.

12. The electronic device of claim 9, wherein the reference image and the edited image are obtained from a multi-turn image editing sequence, and
wherein the multi-turn image editing sequence comprises the reference image, a plurality of sequential edited images corresponding to a plurality of sequential editing instructions, and a final edited image.

13. The electronic device of claim 12, wherein the editing instruction is obtained based on one or more sequential editing instructions from among the plurality of sequential editing instructions,
wherein the edited image comprises a sequential edited image that is generated based on the one or more sequential editing instructions, and
wherein the ground truth editing evaluation score is obtained by performing linear interpolation based on the one or more sequential editing instructions.

14. The electronic device of claim 9, wherein the at least one processor is further configured to execute the instructions to:
obtain a training image corresponding to the reference image and the editing instruction using a pre-trained image editing model; and
perform a fine-tuning training operation based on a comparison between the training image and the edited image to obtain a fine-tuned image editing model.

15. The electronic device of claim 14, wherein to perform the fine-tuning training operation, the at least one processor is further configured to execute the instructions to:
append a reward instruction to the editing instruction to obtain a reward-conditioned editing instruction, wherein the reward instruction corresponds to the editing evaluation score; and
provide the reference image and the reward-conditioned editing instruction to the pre-trained image editing model to obtain the training image; and
obtain the fine-tuned image editing model by modifying at least one parameter of the pre-trained image editing model based on the comparison between the training image and the edited image.

16. The electronic device of claim 15, wherein the at least one processor is further configured to execute the instructions to:
obtain a new reference image and a new editing instruction for editing the new reference image;
append a maximum reward instruction to the editing instruction to obtain a new reward-conditioned editing instruction; and
provide the new reference image and the new reward-conditioned editing instruction to the pre-trained image editing model to obtain an output image.

17. A non-transitory computer-readable medium storing instructions which, when executed by at least one processor of a device for performing image processing, cause the device to:
obtain a reference image and an editing instruction for editing the reference image;
obtain an edited image corresponding to the reference image and the editing instruction;
provide the reference image, the editing instruction, and the edited image to an artificial intelligence (AI) editing evaluation model to obtain an editing evaluation score; and
modify at least one parameter of the editing evaluation model based on a comparison between the editing evaluation score and a ground truth editing evaluation score corresponding to the reference image, the editing instruction, and the edited image.

18. The non-transitory computer-readable medium of claim 17, wherein the reference image and the edited image are obtained from a multi-turn image editing sequence,
wherein the multi-turn image editing sequence comprises the reference image, a plurality of sequential edited images corresponding to a plurality of sequential editing instructions, and a final edited image,
wherein the editing instruction is obtained based on one or more sequential editing instructions from among the plurality of sequential editing instructions,
wherein the edited image comprises a sequential edited image that is generated based on the one or more sequential editing instructions, and
wherein the ground truth editing evaluation score is obtained by performing linear interpolation based on the one or more sequential editing instructions.

19. The non-transitory computer-readable medium of claim 17, wherein the at least one processor is further configured to execute the instructions to:
obtain a training image corresponding to the reference image and the editing instruction using a pre-trained image editing model; and
append a reward instruction to the editing instruction to obtain a reward-conditioned editing instruction, wherein the reward instruction corresponds to the editing evaluation score;
provide the reference image and the reward-conditioned editing instruction to the pre-trained image editing model to obtain the training image; and
obtain a fine-tuned image editing model by modifying at least one parameter of the pre-trained image editing model based on the comparison between the training image and the edited image.

20. The non-transitory computer-readable medium of claim 19, wherein the at least one processor is further configured to execute the instructions to:
obtain a new reference image and a new editing instruction for editing the new reference image;
append a maximum reward instruction to the editing instruction to obtain a new reward-conditioned editing instruction; and
provide the new reference image and the new reward-conditioned editing instruction to the pre-trained image editing model to obtain an output image.
